(19) United States
(12) Patent Application Publication
(10) Pub. No.: US 2019/0178018 A1
(43) Pub. Date: Jun. 13, 2019

(54) A GLASS SOFT-CLOSING SYSTEM FOR SLIDING DOORS

(71) Applicant: Oscar RODRIGUEZ RODRIGUEZ, Benito Juarez. Quintana Roo (MX)

(72) Inventor: Oscar RODRIGUEZ RODRIGUEZ, Benito Juarez. Quintana Roo (MX)

(21) Appl. No.: 16/323,535

(22) PCT Filed: Dec. 9, 2016
(86) PCT No.: PCT/MX2016/000135

§ 371 Date: Feb. 6, 2019

(30) Foreign Application Priority Data
Aug. 10, 2016 (MX) MX/U/2016/000338

(51) Int. Cl. E05F 1/16; E05F 5/00

(52) U.S. Cl. CPC E05F 1/16; E05F 5/003

(57) ABSTRACT

A glass soft closing sliding-door system comprising a right side coupling base with two frontal assembly holes; two back wheels; two central coupling holes; an internal pneumatic pivot; two activators; an action spring; two pivot fasteners; activation lock; a top cover; an independent wheelbarrow that includes two assembly holes; and eight wheels.

Currently, there are a great number of systems for sliding doors, for example, those that include a lengthwise and lateral suspension cart, and a bar mechanism for doors (and windows) which is operated by an incorporated handle on the door (or the window). Another example are the ones that use a structural cross-beam with a spline in the body of the glass panel. Another example are the sliding doors that comprehend rail-rails with rollers that run on the rails, a sliding-doors system supported on the top with a mechanism of a lateral panel. The examples mentioned above have as a limitation the poor aesthetic, they are not reinforced with resistant materials, they are noisy, and they do not have soft-closing system.

This invention seeks to solve this technical problem by adding wheelbarrows with an integrated soft-closing device.

### DESCRIPTION OF THE INVENTION

The novelty of this invention is clearly shown in the drawings that are attached with current application, and according with the description that we detail below so that describe the alpha numeric references correspond to each one of the structural elements that integrate this invention.

### BRIEF DESCRIPTION OF THE FIGURES

FIG. 1, is a disassembled view of the integrated soft-closing device to the wheelbarrows and the structural parts that it is made of that belong in the system.

FIG. 2, is a lengthywise view of the armored wheelbarrows' body and the structural parts that belong in it.

FIG. 3, is a frontal view of the fixing clips to the glass door.

FIG. 4, is a perspective view of the fixing activators and the structural parts that belong in them.

FIG. 5, is a frontal view of the fastening fixing-clips covers.

FIG. 6, is a perspective view of the lower guide of the glass door.

FIG. 7, is a perspective view of the aluminum rail.

FIG. 8, is the frontal view of the installed soft-closing system.

### INDETAILED DESCRIPTION OF THE INVENTION

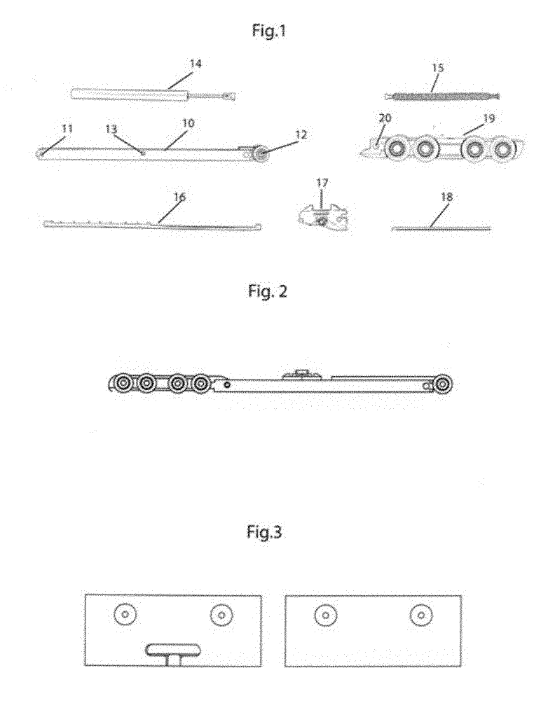

With a reference to FIG. 1, the glass soft-closing sliding-door system that comprehends a right coupling base (10) with two frontal assembly holes (11), two back wheels (12) characterized because each is composed of two components in its main base and weight support by first, an automobile-rigid bear which provides the adequate resistance and operational easiness, the second component consists in a polyethylene cover that helps with the movement of the wheelbarrows to minimize the noise during the displacement inside the rail; two central coupling holes (13), an internal pneumatic pivot (14) activated by a lock (FIG. 4) that when running the door it stretches the pivot's arm, that is hooked to an action spring (15) that at the return's time to its origin the pivot's air provides a slow and soft return; two pivot's fasteners (16), an activation lock (17) located on the central coupling base, top cover (18) of the coupling base; an independent wheelbarrow (19) that comprehends two assembly holes (20), eight wheels characterized because each wheel is composed of two components in its main base and weight support by an automobile-rigid bear which provides the adequate resistance and operational easiness; the second component consists in a polyethylene cover that helps with the movement of the wheelbarrows to minimize the noise during the displacement inside the rail.

The system is designed to function on glass sliding-doors with a weight up to 90 kilograms, which allows that the door slides softly and quietly on the rail, and it provides a cushioned closure through an internal pneumatic pivot (14), the design allows to be installed on glass doors from 10 mm to 12 mm thickness.

1. A glass soft-closing sliding-door system comprising:
a right-side coupling base with two frontal assembly holes;
two back wheels;
two central coupling holes;
in internal pneumatic pivot;
two activators;
an action spring;
two pivot fasteners;
activation lock;
a top cover;
independent wheelbarrow that includes two assembly holes; and
eight wheels.

2. The glass soft-closing sliding-door system according to claim 1, wherein
each one of said wheels is made of two components in main base of glass soft-closing sliding-door system and weight support with an automobile-rigid bear which provides the adequate resistance and operational easiness;
a second component with a polyethylene cover that assist the movement of the wheelbarrows to minimize noise inside a rail.

3. The glass soft-closing sliding-door system according to claim 1, wherein
the glass soft-closing sliding-door system supports glass sliding-doors' weights up to 90 kilograms.

4. The glass soft-closing sliding-door system according to claim 1, wherein
the glass soft-closing, sliding-door system supports the glass sliding doors with a thickness from 10 up to 12 mm.
